(19) United States
(12) Patent Application Publication
(10) Pub. No.: US 2009/0272635 A1
(43) Pub. Date: Nov. 5, 2009

(54) MEMS SWITCH PROVIDED WITH MOVABLE ELECTRODE MEMBER SUPPORTED THROUGH SPRINGS ON SUBSTRATE HAVING BUMP

(76) Inventor: Kenichiro SUZUKI, Otsu-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/265,160

(22) Filed: Nov. 5, 2008

(30) Foreign Application Priority Data
May 1, 2008 (JP) 2008-119798

(51) Int. Cl. H01H 57/00

(52) U.S. Cl. 200/181

(57) ABSTRACT

In a MEMS switch including a movable electrode member, a substrate, a transmission line electrode, and a fixed electrode, the substrate includes a bump formed at a predetermined position to support the movable electrode member at application of a driving voltage. The transmission line electrode is formed on the substrate, and the fixed electrode is formed on the substrate. The movable electrode member includes a movable electrode opposed to the fixed electrode, a first contact opposed to the transmission line electrode, and a second contact opposed to the bump. The movable electrode member is supported between the fixed electrode and the movable electrode at a predetermined initial gap. At application of a predetermined driving voltage to the fixed electrode, the movable electrode member moves in a direction of the substrate by an electrostatic force generated between the fixed electrode and the movable electrode.

### BACKGROUND OF THE INVENTION

1. Field of the Invention

The present invention relates to a MEMS (Micro-Electro-Mechanical System) switch formed using MEMS technique capable of realizing an ultra-fine mechanical mechanism using a fine processing technique for semiconductors.

2. Description of the Related Art

Recently, demand for RF technology has increasingly risen. Various requirements are made of RF devices to follow functional diversification and a sharp increase in users of the RF devices. It is particularly desired to provide low loss and high isolation characteristics as well as downsizing and low cost to a switch because of need of power consumption saving. In such a social background, attention has been paid to MEMS technique for application of portable wireless terminal devices. This is because a MEMS device is characterized by low power consumption, high density packaging, broadband characteristics, and the like.

A MEMS switch has been actively studied mainly in the U.S.A. since the late 1990s. Currently, domestic and overseas companies have started providing MEMS switch samples. These products mainly replace electromagnetic relays and can characteristically downsize devices, and excellent RF characteristics of MEMS switches are expected to create new markets such as that of directional antennas.

Documents related to the present invention are as follows:

Patent Document 1: Japanese patent laid-open publication No. JP-2006-310052-A;

Patent Document 2: Japanese patent laid-open publication No. JP-2006-310053-A;

Non-Patent Document 1: Gabriel M. Rebeiz et al., “RF MEMS Switches and Switch Circuits”, IEEE Microwave Magazine, pp. 59-71, December 2001; and

Non-Patent Document 2: Tomonori SEKI et al., “Development of Electrostatic Actuator for Ohmic-Contact RF MEMS Switch/Relay”, The Institute of Electrical Engineers of Japan (IEEJ) Paper, IEEJ, Volume 126-E Number 2, pp. 65-71, February 2006.

Non-Patent Document 1 discloses study and practical application of MEMS switches. Types of the MEMS switches are classified into a serial resistance type, a parallel resistance type, a serial capacitance type, and a parallel capacitance type. A resistance MEMS switch is characterized in that characteristic impedance is constant in wide frequency bands from a DC band to a high frequency band. A MEMS switch according to a prior art disclosed in Non-Patent Document 2 will be particularly described below as a prior art relevant to the present invention with reference to FIGS. 12 and 13.

FIG. 12 is a perspective view showing a configuration of the MEMS switch according to the prior art and FIG. 13 is a perspective view showing a rear surface of a movable electrode 60 shown in FIG. 12.

The MEMS switch according to the prior art is configured as follows. As shown in FIGS. 12 and 13, strip conductors 51 each including a contact 51c, bonding pads 52, and a fixed electrode 53 are formed on a glass substrate 50, the movable electrode 60 is formed on the strip conductors 51, the bonding pads 52, and the fixed electrode 53, and a cap substrate 70 then covers up the entire constituent elements. In this case, the movable electrode 60 includes anchors 61, projections 62, a movable contact 63, restoring springs 64, and driving electrodes 65. The MEMS switch is structured so that the central movable electrode 60 supported by the two restoring springs 64 are displaced in a direction of the lower substrate by an electrostatic force generated by the voltage applied to the driving electrodes 65 provided on both sides of the movable electrode 60, respectively. Further, at application of no driving voltage to the driving electrodes 65, the movable electrode 60 is displaced in a direction upward of the glass substrate 50 by a restoring force of each of the restoring springs 64. An RF signal line constituted by the strip conductors 51 is formed on the glass substrate 50. The state of the metal movable contact 63 provided on the movable electrode 60 is switched over between the following two states:

(A) such a state that the movable contact 63 contacts with the RF signal line; and

(B) such a state that the movable contact 63 does not contact with the RF signal line.

Then this makes it possible to switch over between ON and OFF states of an electric signal flowing along the RF signal line.

In order to improve the RF characteristics of the MEMS switch according to the prior art, it is necessary to reduce the contact resistance between the movable contact 63 and the strip conductors 51 constituting the RF signal line. The contact force that can be used in a small-sized MEMS switch is as low as several mN or less. Therefore, according to the prior art, a gold-based material having low contact resistance has been used as a material of the movable contact 63.

However, the gold-based material has a relatively high sticking force or adhesion after contact. Due to this, in order to overcome the sticking force, it is necessary to provide springs each having a high spring constant so as to detach the movable contact 63 from the strip conductors 51 of the RF signal line. This results in such a serious problem that driving voltage for driving the device is relatively higher. Therefore, because of the problem that the driving voltage for driving the device is higher (equal to or higher than 40 V), it takes disadvantageously and remarkably long time to achieve practical use of the MEMS switch.

### SUMMARY OF THE INVENTION

It is an object of the present invention to provide a MEMS switch having RF characteristics capable of solving the above-stated problems, remarkably reducing the sticking force as compared with the prior art to turn on or off the switch, greatly reducing driving voltage, and satisfactorily transmitting an RF signal.

In order to achieve the aforementioned objective, according to one aspect of the present invention, there is provided a MEMS switch including a movable electrode member, a substrate, a transmission line electrode, and a fixed electrode. The substrate includes a bump formed at a predetermined position to support the movable electrode member at application of a driving voltage. The transmission line electrode is formed on the substrate, and is made of an electrically conductive material having a predetermined sticking force. The fixed electrode is formed on the substrate, and made of an electrically conductive material. The movable electrode member includes a movable electrode, first and second contacts. The movable electrode is formed to be opposed to the fixed electrode, the first contact is formed to be opposed to the transmission line electrode, and the second contact is formed to be opposed to the bump. The movable electrode member is supported between the fixed electrode and the movable electrode at a predetermined initial gap, and is made of an electrically conductive material. The MEMS switch is configured so that, at application of a predetermined driving voltage to the fixed electrode, the movable electrode member moves in a direction of the substrate by an electrostatic force generated between the fixed electrode and the movable electrode, and so that the first contact and the transmission line electrode contact with each other to turn the first contact and the transmission line electrode into a conductive state. At least one of the bump and the second contact is formed of a material having a sticking force smaller than that of the electrically conductive material of the transmission line electrode.

In the above-mentioned MEMS switch, the material having the smaller sticking force is one of a platinum-based metal, ceramics, and organic resin.

In addition, in the above-mentioned MEMS switch, the substrate is one of a dielectric substrate and a semiconductor substrate, and

Further, in the above-mentioned MEM switch, the electrically conductive material is one of Au, Ag and Cu.

Furthermore, in the above-mentioned MEMS switch, the movable electrode member is supported on the substrate via a spring so that an initial gap between the fixed electrode and the movable electrode is smaller than the predetermined initial gap.

Still further, in the above-mentioned MEMS switch, he movable electrode member includes a slit formed at a position opposed to the transmission line electrode.

Therefore, according to the MEMS switch according to the present invention, at least one of the bump and the second contact is formed of the material having a sticking force smaller than that of the electrically conductive material forming the transmission line electrode. Therefore, the sticking force is reduced, and then, the switch can be repeatedly driven at lower driving voltage by smaller restoring force of the spring. Namely, as compared with the prior art, the switch can be turned on or off with remarkably reducing the sticking force, and then, the driving voltage can be greatly reduced. Furthermore, since the MEMS switch can be manufactured using an LSI process by means of the MEMS technique, high integration can be realized and high reliability can be ensured because of no accumulation of electric charges. Moreover, by forming the slit, the insertion loss can be greatly reduced, band can be made wider, and isolation characteristics can be improved. It is thereby possible to provide the MEMS switch having RF characteristics capable of satisfactorily transmitting RF signals.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a perspective view showing a configuration of a resistance-shunt MEMS switch according to one preferred embodiment of the present invention;

FIG. 2 is a perspective view showing a configuration of the MEMS switch when a movable electrode member 30 shown in FIG. 1 is detached;

FIG. 3 is a perspective view showing a rear surface of the movable electrode member 30 shown in FIG. 1;

FIG. 4A is a longitudinal sectional view showing a first step of manufacturing the MEMS switch shown in FIG. 1;

FIG. 4B is a longitudinal sectional view showing a second step thereof;

FIG. 4C is a longitudinal sectional view showing a third step thereof;

FIG. 4D is a longitudinal sectional view showing a fourth step thereof;

FIG. 5A is a longitudinal sectional view showing a fifth step thereof;

FIG. 5B is a longitudinal sectional view showing a sixth step thereof;

FIG. 5C is a longitudinal sectional view showing a seventh step thereof;

FIG. 6 is a longitudinal sectional view showing an electrode non-contact state (switch-ON state) of the MEMS switch shown in FIG. 1;

FIG. 7 is a longitudinal sectional view showing an electrode contact state (switch-OFF state) of the MEMS switch shown in FIG. 1;

FIG. 8 is a graph showing a comparison in driving voltage among a prior art, a comparative example, and an implemental example;

FIG. 9 is a graph showing a pull-in voltage relative to an initial gap (G) of the MEMS switch shown in FIG. 1;

FIG. 10 is an enlarged view of FIG. 9;

FIG. 11 is a graph showing frequency characteristics relative to insertion loss when presence and absence of a slit 30s of the MEMS switch shown in FIG. 1 and the initial gap “g” are set as parameters;

FIG. 12 is a perspective view showing a configuration of a MEMS switch according to the prior art;

FIG. 13 is a perspective view showing a rear surface of a movable electrode 60 shown in FIG. 12;

FIG. 14 is a longitudinal sectional view showing a configuration of a MEMS switch according to a first modified preferred embodiment of the present invention; and

FIG. 15 is a longitudinal sectional view showing a configuration of a MEMS switch according to a second modified preferred embodiment of the present invention.

### DETAILED DESCRIPTION OF THE PREFERRED EMBODIMENTS

Preferred embodiments according to the present invention will be described hereinafter with reference to the drawings. In the preferred embodiments below, similar constituent elements are denoted by the same reference symbols, respectively.

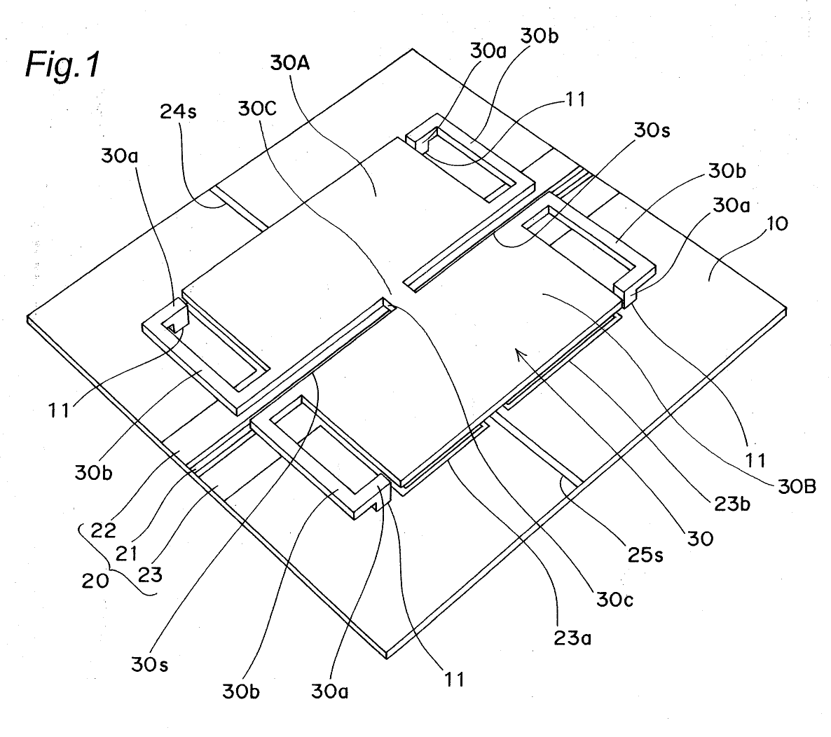

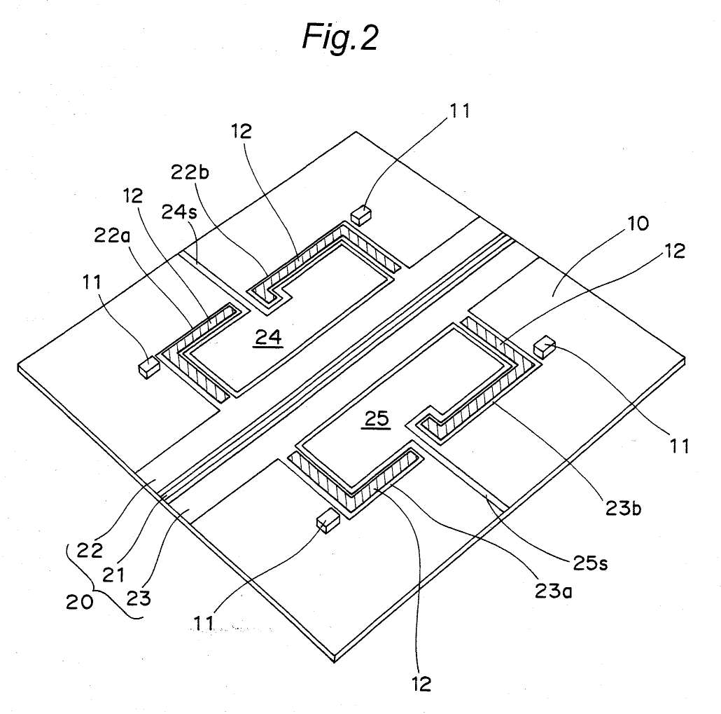

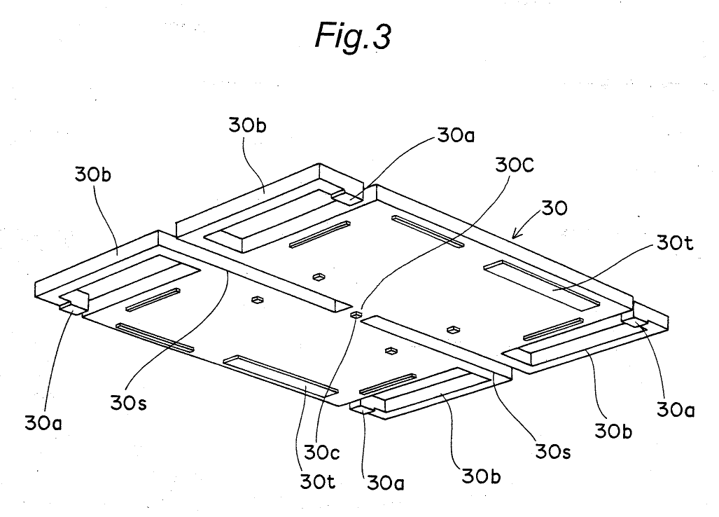

FIG. 1 is a perspective view showing a configuration of a resistance-shunt MEMS switch according to one preferred embodiment of the present invention. FIG. 2 is a perspective view showing a configuration of the MEMS switch when a movable electrode member 30 shown in FIG. 1 is detached. FIG. 3 is a perspective view showing a rear surface of the movable electrode member 30 shown in FIG. 1.

Referring to FIGS. 1 to 3, a coplanar line 20 constituting a transmission line electrode and configured to include a strip conductor 21 and ground conductors 22 and 23 is formed on a silicon substrate 10. Anchors 11 for fixing the movable electrode member 30 are formed on the silicon substrate 10 outward of the coplanar line 20 at four corners of the silicon substrate 10, respectively. Further, substantially rectangular fixed electrodes 24 and 25 are formed on both sides across the coplanar line 20, and strip conductors 24s and 25s serving as leading lines for applying a driving voltage are formed to be connected to the fixed electrodes 24 and 25, respectively. Moreover, extending ground conductors 22a and 22b are formed on the silicon substrate 10 to extend from the ground conductor 22, and extending ground conductors 23a and 23b are formed on the silicon substrate 10 to extend from the ground conductor 23. Further, bumps 12 for supporting the movable electrode member 30 during application of the driving voltage are formed on the extending ground conductors 22a, 22b, 23a, and 23b, respectively.

In this case, each of the strip conductor 21, the ground conductors 22 and 23, and the fixed electrodes 24 and 25 is made of an electrically conductive material having a predetermined sticking force such as Au, Ag or Cu. As described later in detail, the bumps 12 are made of a material having a sticking force smaller than that of the electrically conductive material. Concrete examples of the material of the bumps 12 include platinum-based metal, ceramics, and organic resin. In this case, examples of the platinum-based metal include platinum, palladium, rhodium, osmium, ruthenium, and iridium. Further, the organic resin is Teflon (registered trademark).

The movable electrode member 30 fixed to the anchors 11 so as to cover up a central portion of the silicon substrate 10 includes the following:

(a) rectangular movable electrodes 30A and 30B formed to be opposed to the fixed electrodes 24 and 25, respectively;

(b) a contact 30c formed to be opposed to a central portion of the strip conductor 21;

(c) contacts 30t formed to be opposed to the bumps 12, respectively; and

(d) four beams 30b formed to extend from central portions of two opposed sides of the movable electrodes 30A and 30B to respective anchors 30a each into a thin and long shape, and each including a spring function.

Further, the contact 30c of the movable electrode member 30 is provided immediately under a central bar 30C connecting the movable electrodes 30A and 30B to each other, and two slits 30s are formed to be opposed to the strip conductor 21 of the coplanar line 20 across the central bar 30C. The movable electrode member 30 is fixed to and supported by anchors 10a each at a predetermined initial gap “g” (See FIG. 6) between the fixed electrode 24 or 25 and the movable electrode 30A or 30B via the four beams 30b serving as springs. It is to be noted that the respective components of the movable electrode member 30 are made of the same electrically conductive material such as Au, Ag or Cu.

In the above-stated preferred embodiment, the silicon substrate 10 is employed as a substrate. However, the present invention is not limited to this. The substrate may be constituted by a dielectric substrate or a semiconductor substrate such as a GaAs substrate.

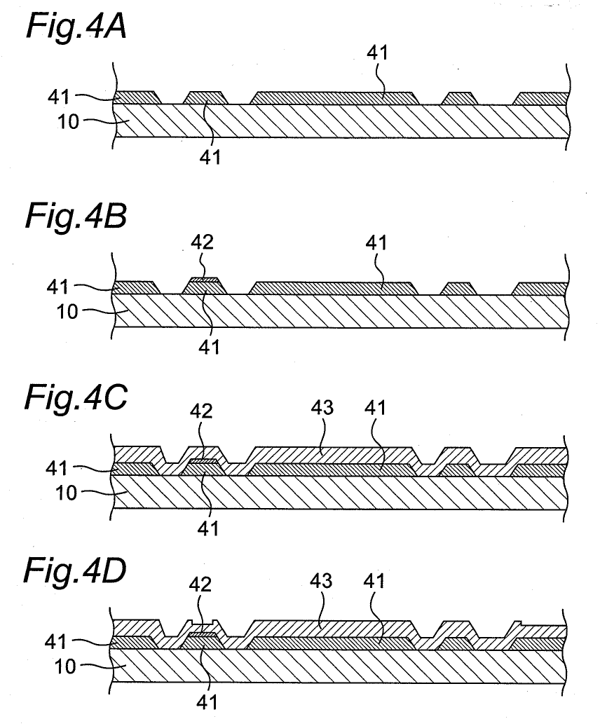

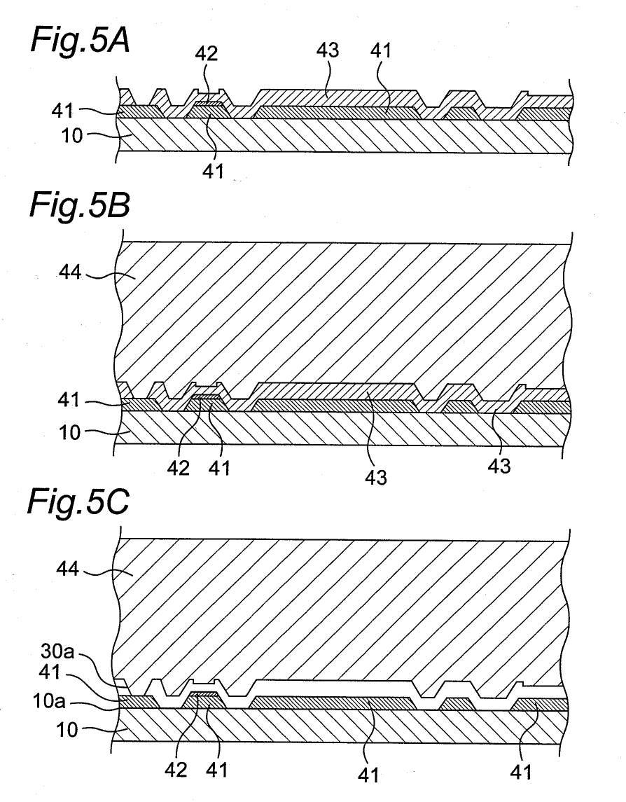

FIGS. 4A to 4D and 5A to 5C are longitudinal sectional views showing steps of manufacturing the MEMS switch shown in FIG. 1. The steps of manufacturing the MEMS switch shown in FIG. 1 will be described with reference to FIGS. 4A to 4D and 5A to 5C.

First of all, as shown in FIG. 4A, an Au layer 41 is formed on the silicon substrate 10 using a predetermined pattern. Thereafter, as shown in FIG. 4B, a Pt layer 42 is formed at positions of the respective bumps 12 using a predetermined pattern. Next, as shown in FIG. 4C, a sacrifice layer 43 made of, for example, aluminum or AlAs is formed to be deposited on the resultant silicon substrate 10. Thereafter, as shown in FIG. 4D, predetermined steps are formed on the sacrifice layer 43 using a liftoff method. Further, as shown in FIG. 5A, portions of the sacrifice layer 43 to correspond to the respective anchors 30a are etched. As shown in FIG. 5B, an Au layer 44 is formed to have a predetermined thickness. As shown in FIG. 5C, the sacrifice layer 43 is removed, thereby obtaining the MEMS switch.

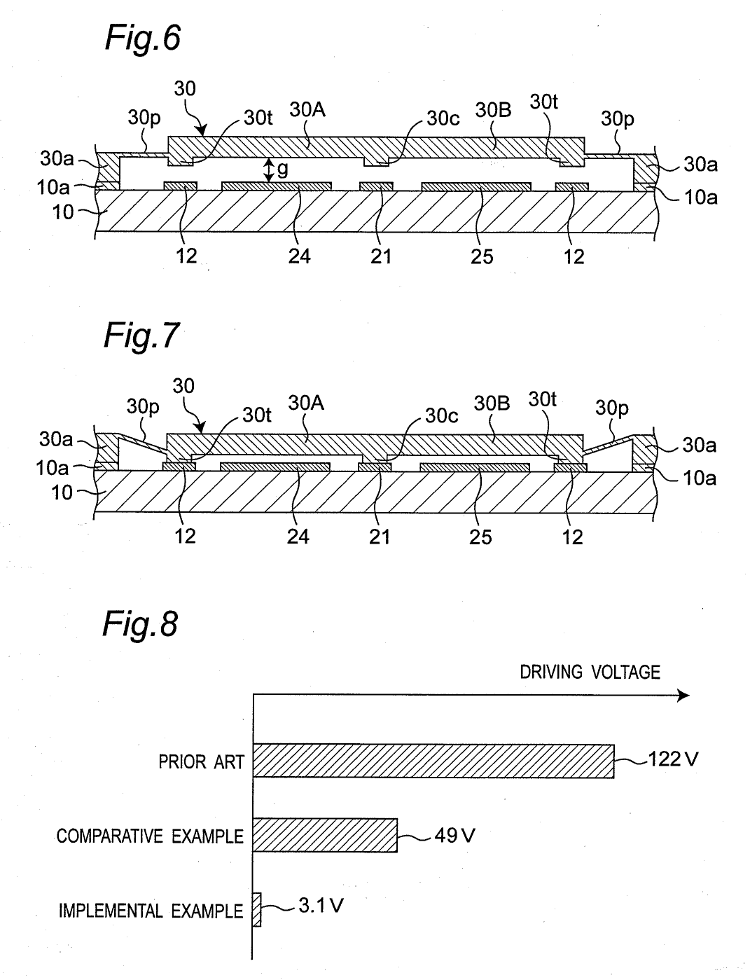

FIG. 6 is a longitudinal sectional view showing an electrode non-contact state of the MEMS switch shown in FIG. 1 (it is such a state that the resistance-shunt switch is turned on). FIG. 7 is a longitudinal sectional view showing an electrode contact state of the MEMS switch shown in FIG. 1 (it is such a state that the resistance-shunt switch is turned off). In FIGS. 6 and 7, the extending ground conductors 22a, 22b, 23a, and 23b between the bumps 12 and the silicon substrate 10 are not shown. Furthermore, in FIGS. 6 and 7, the functions of the four beams 30b are typically shown by being replaced by springs 30p, respectively.

As shown in FIG. 6, at application of no predetermined driving voltage to the fixed electrodes 24 and 25, the movable electrode member 30 is supported by the anchors 10a and 30a on the silicon substrate 10 via the springs 30p so that a gap between the fixed electrode 24 or 25 and the movable electrode 30A or 30B is equal to an initial gap “g”. In this case, the contact 30c and the strip conductor 21 of the coplanar line 20 are out of contact and turned into a nonconductive state, and the resistance-shunt switch is turned on. Next, at application of the predetermined driving voltage to the fixed electrodes 24 and 25, the movable electrode member 30 moves in a direction of the substrate 10 by an electrostatic force generated between the fixed electrode 24 or 25 and the movable electrode 30A or 30B, the contact 30c and the strip conductor 21 of the coplanar line 20 is in contact with each other and turned into a conductive state, and the resistance-shunt switch is turned off. In this case, the contacts 30t of the movable electrode member 30 are supported on the bumps 12, respectively.

The means for solving the problem of the sticking force described in “RELATED ART” part will be next described.

The inventors of the present invention paid attention to a material of the MEMS switch to try to solve the problems. The types of the material of the switch are classified into two groups. As for a first material group of soft metal typified by gold, a sticking phenomenon tends to occur but the first material group is low in contact resistance and excellent as a contact material. As for the other group that is a second material group of hard metal typified by platinum, the sticking phenomenon less occurs but the second material group is high in contact resistance and not so suitable as the contact material. Many switches have been manufactured so far by forming alloy to blend features of the two material groups. In the switch according to the present preferred embodiment, gold is used as the contact material of the contact 30c whereas the bumps 12 are formed of platinum. Generally speaking, if a contact force is stronger, then a contact resistance is smaller and a sticking force is larger. Therefore, the switch according to the present preferred embodiment is configured so that the contact 30c made of gold secures a necessary contact force and an unnecessary contact force is distributed to the bumps 12 made of platinum. In the above arrangement, the switch produced by the inventors of the present invention as a prototype was successfully able to greatly reduce the sticking force down to 0.5 mN when the Pt bumps 12 were used, as compared with the sticking force of 2.7 mN when the switch was formed using only Au. Moreover, the springs 30p having strong restoring force were arranged so as to be able to absorb the remaining sticking force.

By securing the strong restoring force as stated above, the driving voltage rises. However, by setting the initial gap “g” that is an inter-electrode distance smaller than that according to the prior art so as to reduce the driving voltage, the driving voltage can be greatly reduced. In this case, by narrowing the inter-electrode distance, parasitic capacitance between the movable electrode 30A or 30B and the coplanar line 20 increases. In order to solve this problem, the slits 30s are formed, and then, the insertion loss can be remarkably reduced. This win be described later in detail in the following implemental example.

### IMPLEMENTAL EXAMPLE

Table 1 below shows calculated characteristics of the MEMS switch produced by the inventors of the present invention as the prototype.

TABLE 1
Calculated Characteristics

| | Mechanical | Electrical |
|---|---|---|
| Dimensions [μm] | characteristics | characteristics |
| Device size: 500 × 500 | Spring constant: | Pull-in voltage: |
| Initial gap: 0.2 | 3300 N/m | 3.1 V |
| Each beam: 20 × 280 × 18 | Contact force: 0.5 mN | Insertion |
| Each fixed electrode: | Restoring force: 0.5 mN | loss: −0.16 dB |
| 1.35 × 370 | | (70 GHz) |
| | | Isolation: 65 dB |

FIG. 8 is a graph showing comparison in driving voltage among the prior art, a comparative example, and the implemental example. In this case, a switch according to the prior art includes Au bumps 12 and has an initial gap “g” of 3 μm, a switch according to the comparative example includes Pt bumps 12 and has an initial gap “g” of 3 μm, and a switch according to the implemental example includes Pt bumps 12 and has an initial gap “g” of 0.2 μm. As obvious from FIG. 8, by using the Pt bumps 12 and setting the initial gap “g” to be 1/15 as large as that according to the prior art, the driving voltage can be set to 3.1 V at which voltage the switch can be driven by a battery of a portable telephone. This is innovative for practical application of the MEMS switch to such a mobile device as a portable telephone.

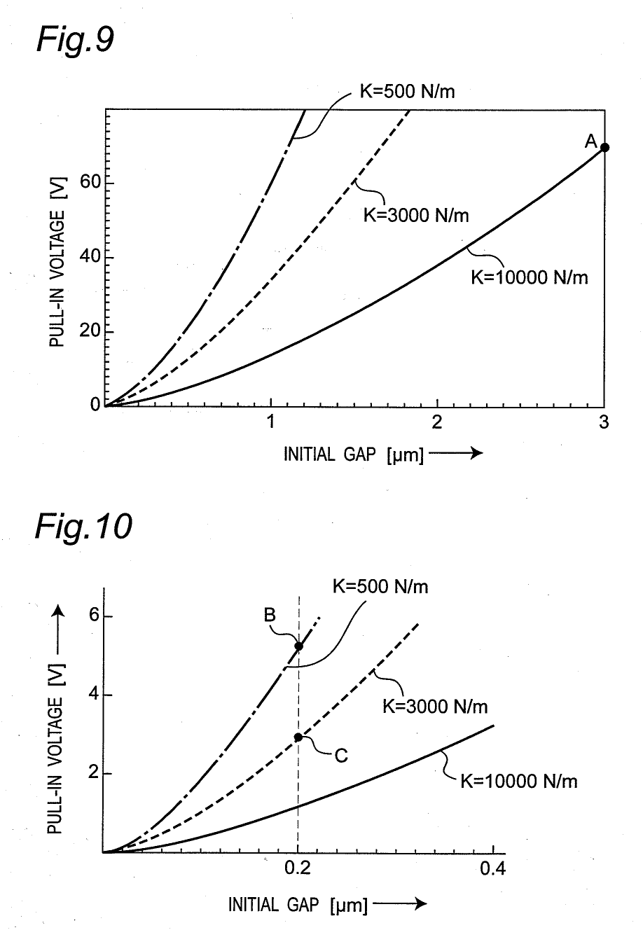

FIG. 9 is a graph showing a pull-in voltage relative to the initial gap “g” of the MEMS switch shown in FIG. 1 and FIG. 10 is an enlarged view of FIG. 9. It is to be noted that the pull-in voltage means a driving voltage relative to each spring constant K. Namely, FIGS. 9 and 10 show the pull-in voltage as a function between the initial gap “g” and each spring constant K. In FIGS. 9 and 10, solid curves and alternate long and short dashed lines show the graph of each of the switches each including the Au bumps 12, and dashed curves shows the graph of the switch including the Pt bumps 12. The switch according to the prior art having the initial gap “g” of 3 μm needs a pull-in voltage of 67 V (A of FIG. 9), and generates a restoring force of 1.5 mN. The switch according to the comparative example having the initial gap “g” of 0.2 μm needs a pull-in voltage of 5.2 V (B of FIG. 10), and generates the same restoring force as that generated by the switch A. By contrast, the switch according to the present implemental example including the Pt bumps 12 and having the initial gap “g” of 0.2 μm needs only a pull-in voltage of 3.1 V (C of FIG. 10) because of reductions in the sticking force and in the necessary restoring force. Nevertheless, a narrower initial gap “g” generally deteriorates RF characteristics due to an increase in capacitance of a region of the contact 31c.

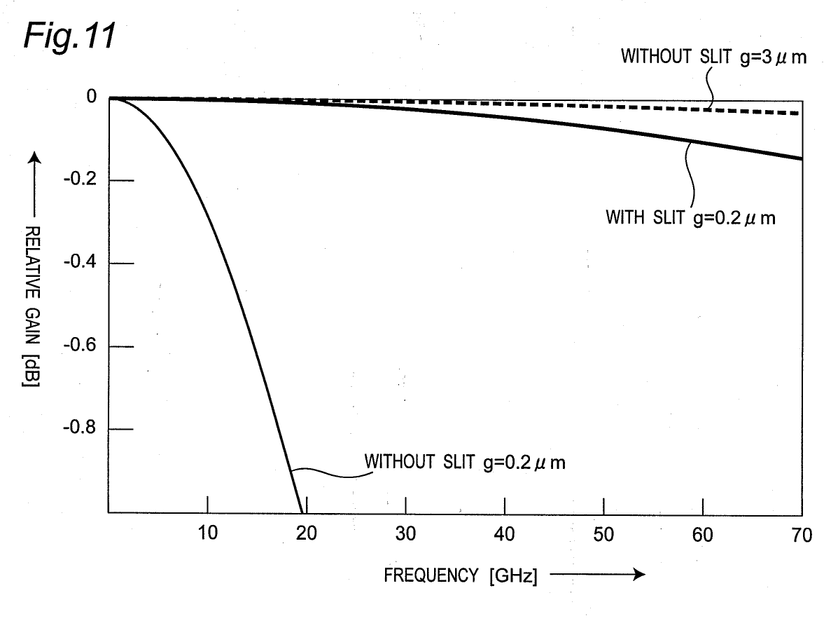

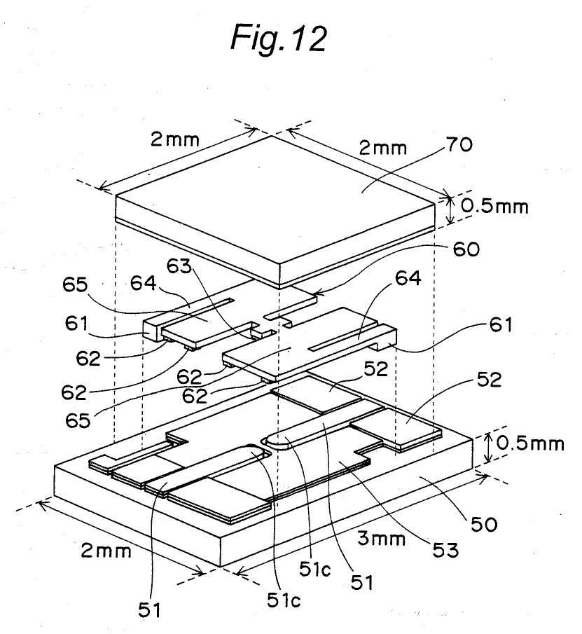

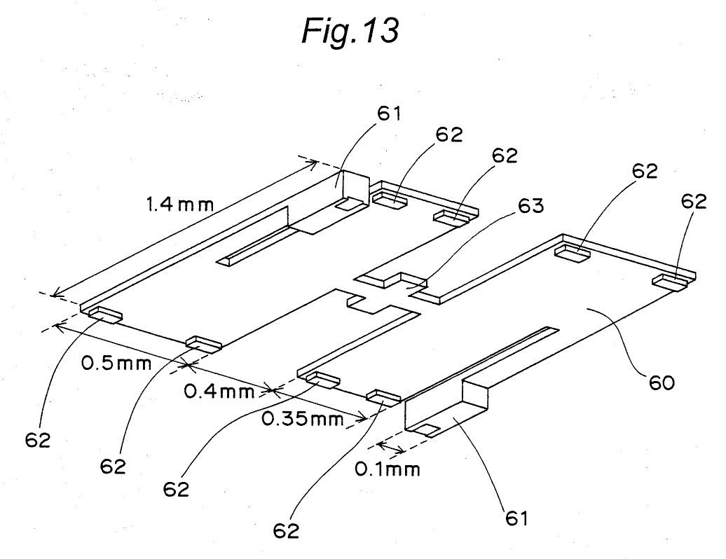

FIG. 11 is a graph showing frequency characteristics relative to insertion loss when presence and absence of slits 30s of the MEMS switch shown in FIG. 1 and the initial gap “g” are set as parameters. As obvious from FIG. 11, when the MEMS switch has no slit 30s and the initial gap “g” of 0.2 μm, very large insertion loss occurs. However, by providing the slits 30s, the insertion loss is as small as −0.16 dB at a frequency of 70 GHz.

### MODIFIED PREFERRED EMBODIMENTS

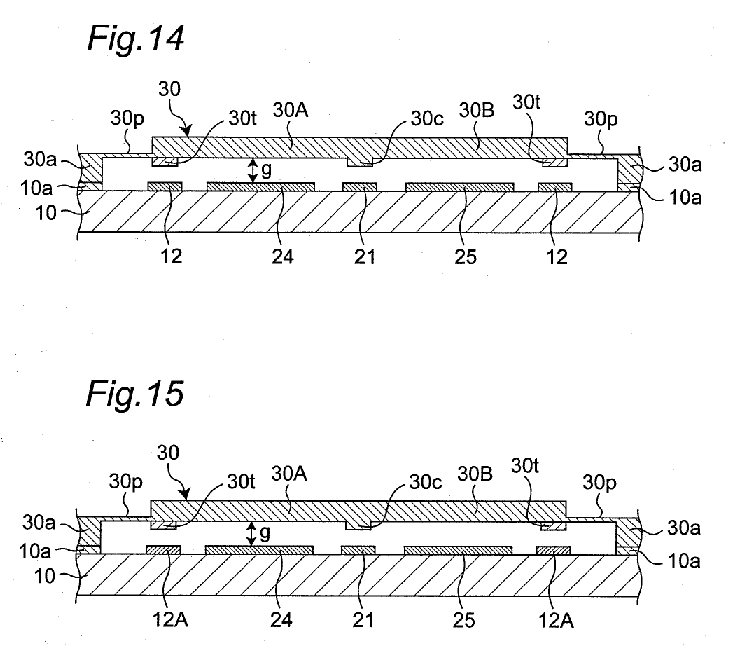

FIG. 14 is a longitudinal sectional view showing a configuration of a MEMS switch according to a first modified preferred embodiment of the present invention. In the preferred embodiment shown in FIG. 6, the contacts 30t are formed of the same material as that of the movable electrode member 30. However, the present invention is not limited to this. As shown in FIG. 14, the contacts 30t may be formed of a material such as hard metal, e.g., platinum, having lower sticking force. Referring to FIG. 14, bumps 12 are also formed of the material such as the hard metal, e.g., platinum, having lower sticking force.

FIG. 15 is a longitudinal sectional view showing a configuration of a MEMS switch according to a second modified preferred embodiment of the present invention. As compared with the first modified preferred embodiment shown in FIG. 14, not the bumps 12 but bumps 12A are formed of material such as hard metal, e.g., Au, having higher sticking force.

Namely, as obvious from FIGS. 6, 14, and 15, at least either the contacts 30t or the bumps 12 may be formed of the material such as the hard metal, e.g., platinum, having the lower sticking force (as compared with the sticking force of soft metal such as gold).

### INDUSTRIAL APPLICABILITY

Accordingly, as mentioned above in details, according to the MEMS switch according to the present invention, at least one of the bump and the second contact is formed of the material having a sticking force smaller than that of the electrically conductive material forming the transmission line electrode. Therefore, the sticking force is reduced, and then, the switch can be repeatedly driven at lower driving voltage by smaller restoring force of the spring. Namely, as compared with the prior art, the switch can be turned on or off with remarkably reducing the sticking force, and then, the driving voltage can be greatly reduced. Furthermore, since the MEMS switch can be manufactured using an LSI process by means of the MEMS technique, high integration can be realized and high reliability can be ensured because of no accumulation of electric charges. Moreover, by forming the slit, the insertion loss can be greatly reduced, band can be made wider, and isolation characteristics can be improved. It is thereby possible to provide the MEMS switch having RF characteristics capable of satisfactorily transmitting RF signals. In particular, the MEMS switch according to the present invention is useful for use in RF-MEMS device such as mobile telephones and wireless LAN systems.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A MEMS switch comprising:
a movable electrode member;
a substrate having a bump formed at a predetermined position to support the movable electrode member at application of a driving voltage;
a transmission line electrode formed on the substrate, and made of an electrically conductive material having a predetermined sticking force; and
a fixed electrode formed on the substrate, and made of an electrically conductive material;
wherein the movable electrode member comprises:
a movable electrode formed to be opposed to the fixed electrode;
a first contact formed to be opposed to the transmission line electrode; and
a second contact formed to be opposed to the bump,
wherein the movable electrode member is supported through springs between the fixed electrode and the movable electrode at a predetermined initial gap, and made of an electrically conductive material,
wherein the MEMS switch is configured so that, at application of a predetermined driving voltage to the fixed electrode, the movable electrode member moves in a direction of the substrate by an electrostatic force generated between the fixed electrode and the movable electrode, and so that the first contact and the transmission line electrode contact with each other to turn the first contact and the transmission line electrode into a conductive state, and
wherein at least one of the bump and the second contact is formed of a material having a sticking force smaller than that of the electrically conductive material of the transmission line electrode.

2. The MEMS switch as claimed in claim 1,
wherein the material having the smaller sticking force is one of a platinum-based metal, ceramics, and organic resin.

3. The MEMS switch as claimed in claim 1,
wherein the substrate is one of a dielectric substrate and a semiconductor substrate, and
wherein the electrically conductive material is one of Au, Ag and Cu.

4. The MEMS switch as claimed in claim 1,
wherein the movable electrode member is supported on the substrate via a spring so that an initial gap between the fixed electrode and the movable electrode is smaller than the predetermined initial gap.

5. The MEMS switch as claimed in claim 1,
wherein the movable electrode member includes a slit formed at a position opposed to the transmission line electrode.
